(19) United States
(12) Patent Application Publication
(10) Pub. No.: US 2006/0221085 A1
(43) Pub. Date: Oct. 5, 2006

(54) Information processing apparatus and program

(75) Inventor: Kazutaka Yamada, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/390,357

(22) Filed: Mar. 28, 2006

(30) Foreign Application Priority Data
Mar. 30, 2005 (JP) 2005099258

(51) Int. Cl. G06F 3/12; G06T 1/00

(52) U.S. Cl. 345/501; 358/1.1

(57) ABSTRACT

An information processing apparatus having a print preview function, includes: a setting unit that sets preview objects; a list display unit that displays a list of the preview objects set by the setting unit on a display device; a selection unit that selects at least one of the preview objects based on a selection instruction input from an input device from the list displayed on the display device; an image data creating unit that creates print preview image data showing a print output result with respect to user data corresponding to the preview object selected by the selection unit; and a preview unit that displays, on the display device, an image based on the print preview image data.

### CROSS-REFERENCE TO THE RELATED APPLICATION(S)

This application is based upon and claims a priority from prior Japanese Patent Applications No. 2005-099258 filed on Mar. 30, 2005, the entire contents of which are incorporated herein by reference.

### TECHNICAL FIELD

The present invention relates to an information processing apparatus having a print preview function and a program.

### BACKGROUND

An information processing apparatus having a print preview function has been widely known as a conventional information processing apparatus. The print preview function means a function of displaying an image showing a print output result on a display device so that a user can check the image of data, which will be printed out by a printing device, before the print is output.

In the information processing apparatus having the print preview function, for example, when a user instructs the information processing apparatus to execute the print preview function by manipulating an input device, such as a keyboard or a pointing device, a program which is installed in application software so as to execute the print preview function is executed, and an image showing a print output result with respect to data dealt with by the application software is displayed on a display device.

In addition, there is known an information processing apparatus in which a plurality of pages of preview images are created so as to be disposed in parallel to one another and the preview images are displayed on a display device (for example, see JP-A-11-203099).

### SUMMARY

However, the conventional information processing apparatus does not have a function that a user collectively manages a plurality of data which is objects to be previewed. Accordingly, when the user desires to check print output results with respect to the plurality of data beforehand, the user should perform many procedures, for example, manipulate an input device so as to execute application software capable of creating a preview image for each data in the information processing apparatus and input an instruction on whether or not to perform a preview with respect to the application software. That is, the operability in displaying the print output results with respect to the plurality of data on the display device is not good in the related art.

In order to solve the above-mentioned problems, it is an object of the invention to improve the operability in displaying print output results with respect to a plurality of data on a display device.

According to an aspect of the invention, there is provided an information processing apparatus having a print preview function, including: a setting unit that sets preview objects; a list display unit that displays a list of the preview objects set by the setting unit on a display device; a selection unit that selects at least one of the preview objects based on a selection instruction input from an input device from the list displayed on the display device; an image data creating unit that creates print preview image data showing a print output result with respect to user data corresponding to the preview object selected by the selection unit; and a preview unit that displays, on the display device, an image based on the print preview image data.

In the information processing apparatus having the configuration described above, since a list of the preview object is displayed and a preview screen (image based on print preview image data) with respect to user data dealt with by the preview object selected by a user is displayed, the user can check the print output result with respect to desired data only by inputting the selection instruction through the input device on the basis of the list.

That is, in a case in which there is a plurality of data that the user desires to check print output results, the user should execute application software for each data in an information processing apparatus and display a preview screen for each data in the related art; however, in the invention, the user can check print output results with respect to the plurality of data only by a selective manipulation. As such, according to the invention, it is possible to improve the operability in checking the print output results with respect to the plurality of data on the display device, as compared with that in the related art.

According to another aspect of the invention, there is provided a computer program product for enabling a computer to have a print preview function, comprising: software instructions for enabling the computer to perform predetermined operations; and a computer readable medium bearing the software instructions, wherein the predetermined operations includes: setting a preview object; displaying a list of the preview object set by the setting; selecting at least one of the set preview objects based on a selection instruction input on the basis of the list; creating print preview image data showing a print output result with respect to user data corresponding to the preview object selected by the selecting; and displaying an image based on image data created by the creating.

According to the program, it is possible to obtain the same effects as in the information processing apparatus described above.

### BRIEF DESCRIPTION OF THE DRAWINGS

These and other objects and advantages of the present invention will be more fully apparent from the following detailed description taken in conjunction with the accompanying drawings, in which:

FIG. 1 is an explanatory view illustrating the configuration of an information processing apparatus 1 to which the invention is applied;

FIG. 2 is an explanatory view illustrating an operation of a multi-task OS;

FIG. 3 is a flow chart illustrating an operation of a CPU 11;

FIG. 4 is an explanatory view illustrating the configuration of a window management table.

FIG. 5 is an explanatory view illustrating the configuration of a registered application management table;

FIG. 6 is an explanatory view illustrating the configuration of a dialogue displayed in a process S150;

FIG. 7A is an explanatory view illustrating the configuration of a main screen GM;

FIG. 7B is an explanatory view illustrating the configuration of a main screen GM;

FIG. 8 is a flow chart illustrating a data creating process performed by the CPU 11; and

FIG. 9 is a flow chart illustrating a main preview process performed by the CPU 11.

### DETAILED DESCRIPTION OF THE ILLUSTRATIVE ASPECTS

Hereinafter, an illustrative aspect of the invention will be described with reference to the accompanying drawings.

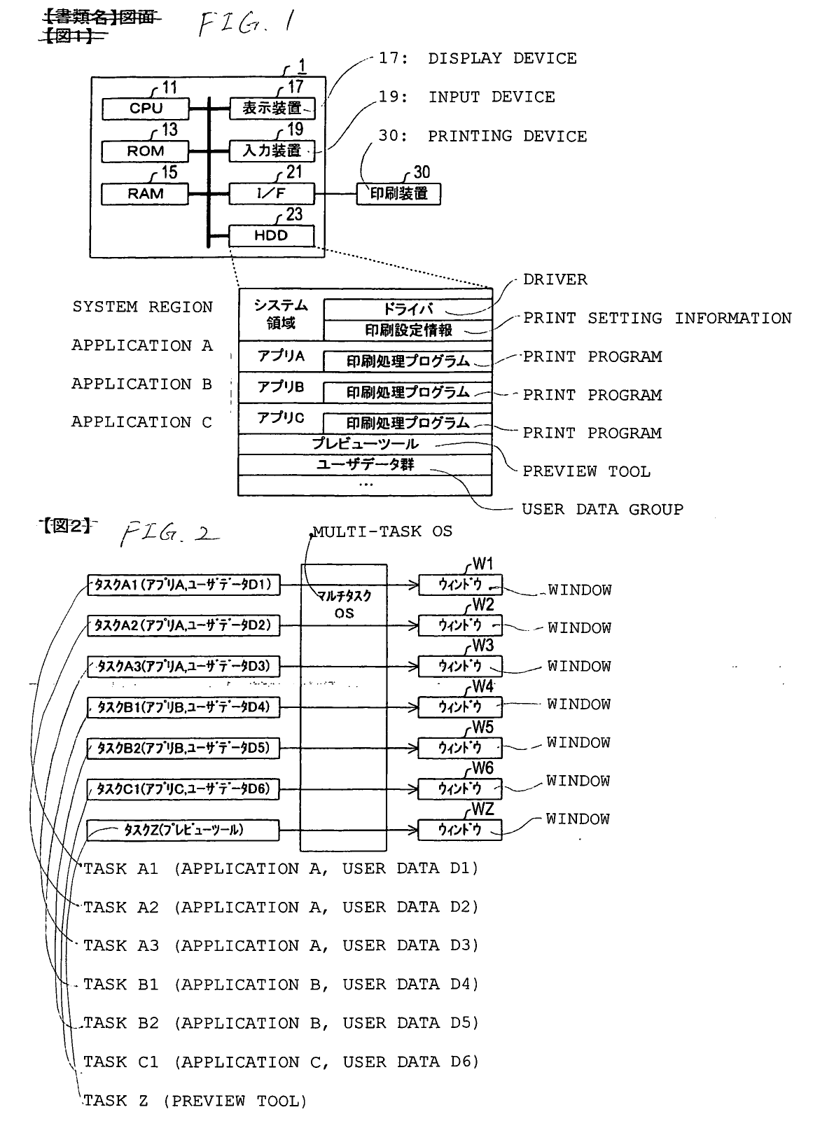

FIG. 1 is an explanatory view illustrating the construction of an information processing apparatus 1 to which the invention is applied.

The information processing apparatus 1 according to the present illustrative aspect is constructed in the same manner as a well-known personal computer, and includes a CPU 11 which performs various operations according to a program, a ROM 13 which stores a boot program or the like, a RAM 15 used as an operation region when a program is executed by the CPU 11, a display device 17 which is composed of, for example, a liquid crystal monitor so as to display various information, an input device 19, such as a keyboard or a pointing device, which a user can operate, an interface 21 communicatably connected to a printing device (printer) 30, and a hard disc device 23 which stores a program, data, or the like.

The information processing apparatus 1 is operated by a multi-task OS (operating system). On a system region of the hard disc device 23, a data group or a program group that allows the CPU 11 to perform a function of the multi-task OS is stored. On the system region, a driver program for controlling the printing device 30, print setting information which is setting information on a printing method, or the like are also stored.

In addition, a plurality of kinds of application softwares executed under the multi-task OS are stored in the hard disc device 23. Specifically, as one application software, a program tool (preview tool) that allows the CPU 11 to function as respective units of the invention is stored in the hard disc device 23. In addition, user data (document file) that a task based on the various application softwares has created according to input information of a user is stored in the hard disc device 23.

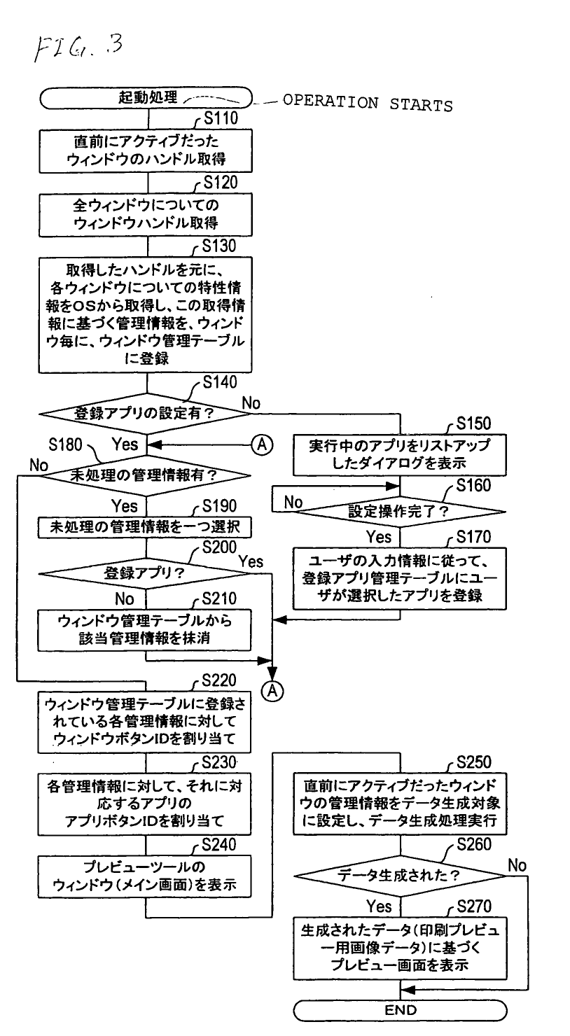

FIG. 2 is an explanatory view illustrating an operation of the multi-task OS in the present illustrative aspect. In the information processing apparatus 1 of the present illustrative aspect, the CPU 11 executes a boot program stored in the ROM 13 when power is on, and then executes a program stored in the system region so as to drive the multi-task OS. As shown in FIG. 2, in a case in which the multi-task OS of the present illustrative aspect is used, a plurality of windows for displaying information can be displayed on the display device 17. Specifically, application software instructed by a user is executed when the instruction of the user is input from the input device 19, a window is created according to instruction of a task based on the application software, and the window is displayed on the display device 17 and an information display is performed within the window according to the instruction of the task.

Further, in the case of the multi-task OS of the present illustrative aspect, it is possible to assign a plurality of windows for single application software (for example, Windows™.

For example, in the information processing apparatus 1 of the present illustrative aspect, when a user instructs application software A, such as word processor software or drawing software, to be executed while designating user data D1, the multi-task OS sets the user data D1 to an argument and executes the application software A instructed by the user, thereby creating a task A1 based on the application software A dealing with the user data D1. In addition, when the task A1 instructs a window W1 to be created, the multi-task OS creates the new window W1 on the display device 17.

In addition, when the user instructs the application software A to be executed while designating user data D2, the multi-task OS sets the user data D2 to an argument and executes the application software A instructed by the user, thereby creating a task A2 based on the application software A dealing with the user data D2. In addition, when the task A2 instructs a window W2 to be created, the multi-task OS creates the new window W2 on the display device 17.

Furthermore, a task, which is created by the instruction (instruction to open a file) of a user to display data and is based on application software, such as word processor software or drawing software, performs a display process for user data instructed by the user so as to display information based on the user data D on the window created by the multi-task OS.

Specifically, in the present illustrative aspect, the task A1 based on the application software A performs a display process for the user data D1 so as to display information on the data D1 on the window W1, the task A2 based on the application software A performs a display process for the user data D2 so as to display information on the data D2 on the window W2, and a task A3 based on the application software A performs a display process for user data D3 so as to display information on the data D3 on a window W3.

Further, in the present illustrative aspect, it is assumed that a task B1 based on application software B performs a display process for user data D4 so as to display information on the data D4 on a window W4, a task B2 based on application software B performs a display process for user data D5 so as to display information on the data D5 on a window W5, and a task C1 based on application software C performs a display process for user data D6 so as to display information on the data D6 on a window W6. Here, this assumption is made so as to make the invention easily understood, and the invention is not limited to the above-mentioned specific configuration.

Furthermore, in the information processing apparatus 1 of the present illustrative aspect, when a user's instruction to execute a preview tool is input from the input device 19, the preview tool stored in the hard disc device 23 is executed by the multi-task OS and a task Z (that is, CPU 11) performs an operation shown in FIG. 3. FIG. 3 is a flow chart illustrating the operation.

When the operation starts, the task Z inquires the multi-task OS of handle of a window which was active immediately before the preview tool is executed, and acquires the handle (window handle) with respect to the active window (S110). In addition, the task Z inquires the multi-task OS of handle (window handle) with respect to all of the created windows, and acquires the information (handle with respect to all of the created windows) (S120). In addition, the window handle serves as identification information on a window.

When the process S120 is completed, the task Z acquires characteristic information on all of the created windows on the basis of the window handle acquired in the process S120 (S130). Specifically, the task Z designates window handle for each window and inquires the multi-task OS of the characteristic of a window corresponding to the window handle, thereby acquiring the characteristic information on each window from the multi-task OS.

Further, in the present illustrative aspect, as the characteristic information, window title information representing a title of a window, path information of an execution module (that is, an execution file of application software) corresponding to a window, and information (file information) on user data which is displayed on the window by a task based on the execution module.

Then, on the basis of the acquired characteristic information on each window, management information on each of the created windows is registered in a window management table stored in the RAM 15 (S130).

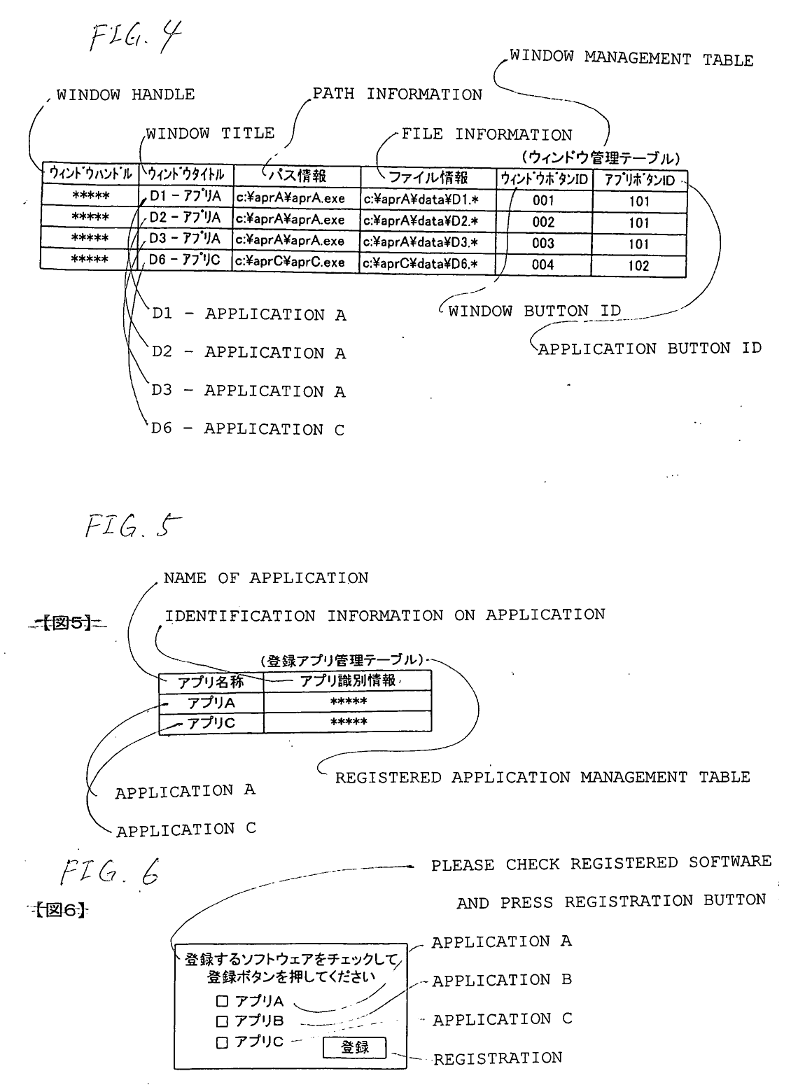

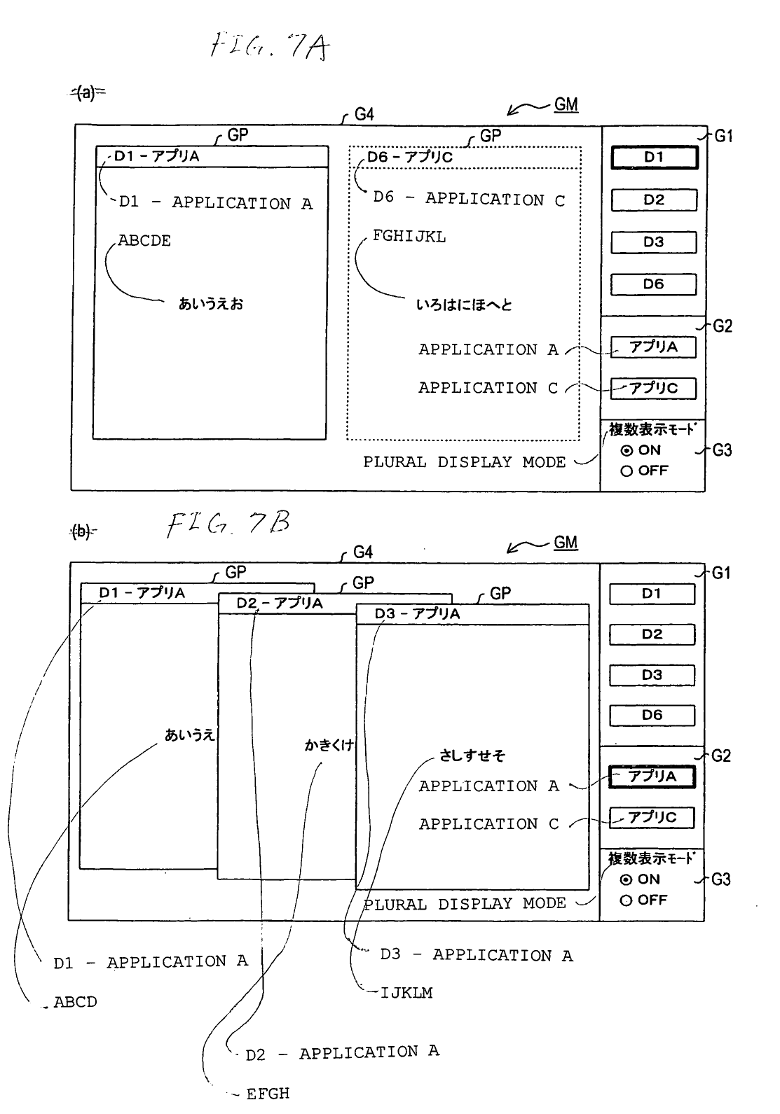

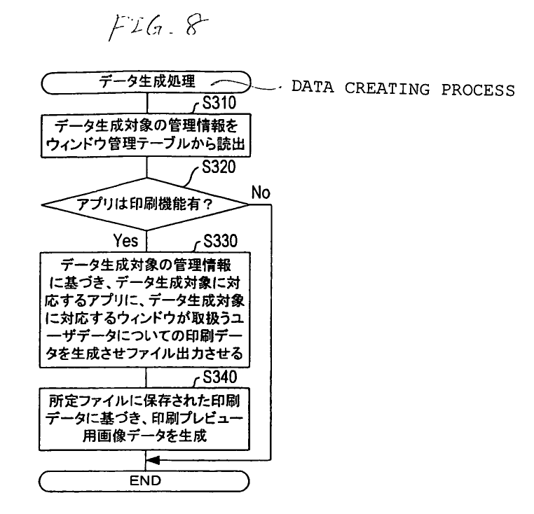

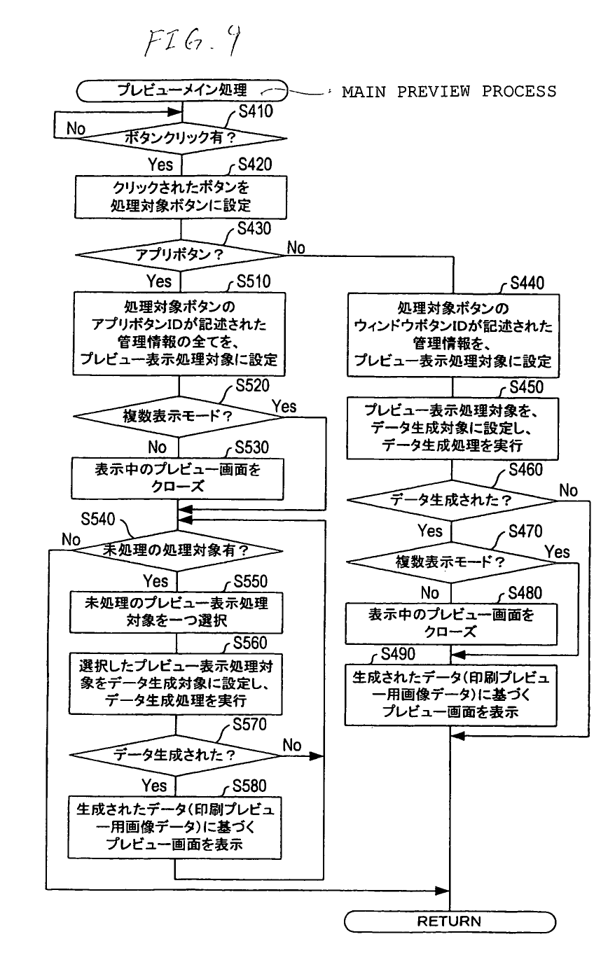

FIG. 4 is an explanatory view illustrating the configuration of the window management table. As shown in FIG. 4, in the window management table, management information, which is composed of window handle with respect to each window, window title information, path information of an execution module, information (file information) on user data which is open on the window, a window button ID to be described below, and an application button ID, is registered for each window. In addition, in the process S130, the window button ID and the application button ID are registered as empty information.

When the process S130 is completed, in a process S140, the task Z determines whether or not application software is registered in a registered application management table stored in the hard disc device 23. FIG. 5 is an explanatory view illustrating the configuration of the registered application management table. As shown in FIG. 5, in the registered application management table, registered application information, which is composed of a name of application software and identification information (specifically, path information of an execution module) on the application software, is registered as registered information on the application software for each application software.

If it is determined that the application software is not registered (that is, the registered application management table is empty) in the registered application management table in the process S140, the task Z displays a dialogue, on which application software being executed is listed up, on the display device 17 (S150).

FIG. 6 is an explanatory view illustrating the configuration of a dialogue displayed in the process S150. As shown in FIG. 6, the title of application software being executed is displayed on the dialogue displayed in the process S150. In addition, the dialogue allows application software that a user wants to be selected through the input device 19.

Specifically, in an example shown in FIG. 6, a check box is added for each application software which can be selected, such that the dialogue can select application software. In addition, in the dialogue, the title of the application software can be displayed, for example, on the basis of the window title information acquired in the process S130.

When the process S150 is completed, the task Z waits until a user completes a setting operation based on the dialogue (S160). Specifically, here, it is determined that the setting operation has been completed when a registration button of the dialogue is clicked (pressed) through the input device 19 under a state in which one or more application softwares are checked, and in other cases, it is determined that the setting operation has not been completed.

If it is determined that the setting operation has been completed in the process S160, the task Z registers registered application information on the application software that the user selected in the registered application management table on the basis of information on the dialogue input by the user (S170). In addition, the registered application information is created on the basis of the characteristic information of a window acquired in the process S130.

The process S170 may be completed, or if it is determined that application software is registered in the registered application management table in the process S140, the task Z proceeds to a process S180 so as to determine whether or not management information, which is not processed in a process S190, is registered in the window management table.

Then, if it is determined that there is the management information which is not processed (Yes in the process S180), the task Z proceeds to the process S190 in which one management information which is not processed is selected from the window management table, and then it is determined whether or not a window corresponding to the selected management information is a window corresponding to the registered application software on the basis of path information included in management information and identification information (path information) of application software registered in the registered application management table (S200).

Subsequently, if it is determined that the window corresponding to the selected management information is not a window corresponding to the registered application software (No in the process S200), the management information selected from the window management table is deleted (S210), proceeding to the process S180.

On the other hand, if it is determined the window corresponding to the selected management information is a window corresponding to the registered application software (Yes in the process S200), the process S210 is not performed, proceeding to the process S180 under a state in which the management information is held in the window management table. Then, if a process subsequent to the process S190 is performed for all of the management information registered on the window management table, No is determined in the process S180, proceeding to a process S220.

In such processes, only the management information corresponding to the window of the application software registered in the registered application management table is held in the window management table. For example, at a time when a preview tool is executed, the windows W1 to W6 are displayed on the display device 17 as shown in FIG. 2, the management information corresponding to the windows W4 and W5 corresponding to the application software B is deleted from the window management table if only the application software A and the application software C are registered in the registered application management table, and the management information corresponding to the windows W1, W2, W3, and W6 corresponding to the application software A and the application software C are held in the window management table at a point of time proceeding to the process S220 as shown in FIG. 4.

In the process S220, for each management information registered in the window management table, the task Z assigns a unique window button ID, adds information on the assigned window button ID to management information corresponding thereto, and updates each management information stored in the window management table. In addition, the window button ID is provided to associate a window button displayed on the main screen GM (refer to FIGS. 7A and 7B) with the management information. Since the unique window button ID is assigned for each management information in the process S220, each management information (that is, each window) corresponds to one of the window buttons displayed on the main screen GM, respectively.

When the process S220 is completed, for each management information registered in the window management table, the task Z assigns an application button ID, adds information on the assigned application button ID to management information corresponding thereto, and updates each management information stored in the window management table (S230). In addition, the application button ID is a unique ID for each application software and is provided to associate an application button displayed on the main screen GM with the management information.

In the process 230, it is determined on which kind of application software a task managing a window corresponding to management information is based according to path information of an execution module, and the application button ID of the application software corresponding to the management information is assigned according to the kind of the application software.

For example, as shown in FIG. 4, with respect to management information on the windows W1, W2, and W3 managed by the tasks A1, A2, and A3 based on the same application software A, the same application button ID ‘101’ is assigned, and with respect to management information on the window W6 managed by the task C1 based on the application software C different from the application software A, application button ID ‘102’ different from the application button ID ‘101’ corresponding to the application software A is assigned.

When the process S230 is completed, the task Z instructs the multi-task OS to create a window WZ, displays the window WZ for a preview tool on the display device 17, and displays the main screen GM on which a window button ID and an application button ID are arranged in this order on the right side of the window WZ (S240).

FIGS. 7A and 7B are explanatory views illustrating the configuration of the main screen GM. As shown in FIGS. 7A and 7B, on the right side of the main screen GM, a window button display screen G1, an application button display screen G2, and an ON/OFF switching screen G3 of a plural display mode are included, and on the left side of the main screen GM, a display screen G4 for a preview screen GP is included.

In the process S240, the task Z arranges window buttons corresponding to the respective window button IDs on the display screen G1 in the order of ID and displays, on each window button, a character string included in window title information of the management information assigned with the window button ID. In addition, the task Z arranges application buttons corresponding to the respective application button IDs on the display screen G2 in the order of ID and displays, on each application button, a character string representing a title of the application software corresponding to the application button ID.

In addition, the entire character string included in the window title information or a part of the character string may be display on a window button. For example, since a character string included in window tile information is long when the name of user data and the title of application software are included in a window title, it is preferable to display only the name of the user data on the window button.

When the process S240 is completed, on the basis of the window handle acquired in the process S110, the task Z sets management information on a window, which was active immediately before the process S240 is completed, to an object (object for which data is to be created) for which print preview image data is to be created, and performs a data creating process shown in FIG. 8 (S250). FIG. 8 is a flow chart illustrating the data creating process performed by the task Z.

When the data creating process is performed, the task Z reads out management information on an object for which data is to be created, which has been set beforehand, from the window management table (S310), determines application software corresponding to the object for which data is to be created on the basis of the management information, and determines whether or not the application software has a print function (that is, a print program) (S320).

If it is determined that the application software corresponding to the object for which data is to be created does not have the print function (No in the process S320), the process of creating the corresponding data is completed without creating the print preview image data.

On the other hand, if it is determined that the application software corresponding to the object for which data is to be created has the print function (Yes in the process S320), the task Z proceeds to a process S330 in which, on the basis of the management information on the object for which data is to be created, print data with respect to the user data displayed by a task, which manages a window corresponding to the management information on object for which data is to be created, is created by using a print program included in application software corresponding to the object for which data is to be created (S330). Specifically, the user data, which is an object to be printed, and an output location (output location file) are designated and the print program of the application software is called, thereby creating print data with respect to the designated user data. In addition, the print data is generally input to the printing device 30; however, here, the print data is created in a file by setting the output location to the file (specifically, a so-called PRN file or PS file).

Thereafter, the task Z reads out the print data created by the print program from the hard disc device 23 and converts the print data to print preview image data (S340). Specifically, when the print data is converted to the print preview image data, a color space may be converted to an RGB color space or the resolution may be converted to a resolution for print preview.

As such, when the print preview image data is created, the task Z completes the data creating process under a state in which the print preview image data is stored in the RAM 15.

When the data creating process is completed in the process S250, the task Z determines whether or not print preview image data has been created by the data creating process (S260), and if it is determined that the print preview image data is not created (No in the process S260), the corresponding operation is completed.

On the other hand, if it is determined that the print preview image data has been created by the data creating process in the process S250 (Yes in the process S260), the preview screen GP based on the print preview image data is displayed within a display screen G4 (S270). In addition, a character string included in the window title information indicated by the management information of the object for which data is to be created is displayed on the upper side of the preview screen GP displayed in the process S270, and an image (that is, a print output result with respect to user data dealt with in a window corresponding to management information) based on the print preview image data is displayed on the lower side of the preview screen GP displayed in the process S270.

When the process S270 is completed, the task Z completes the corresponding operation and then repeats a main preview process. FIG. 9 is a flow chart illustrating the main preview process performed by the task Z.

When the main preview process is performed, the task Z waits until a user clicks a window button or an application button on the main screen GM through the input device 19 (S410), and then when the window button or the application button is clicked (Yes in the process S410), the task Z sets the clicked window button or the clicked application button to an object to be processed (S420). Then, the task Z determines whether or not the button to be processed is an application button (S430), and then if it is determined that the button to be processed is not an application button (No in the process S430), the task Z sets management information, in which a window button ID corresponding to the button to be processed is included, to an object to be subjected to a preview process (S440). Then, the management information on the object to be subjected to a preview process is set to an object for which data is to be created and the data creating process (refer to FIG. 8) described above is performed (S450).

Further, when the data creating process is completed in the process S450, the task Z proceeds to a process S460 in which it is determined whether or not print preview image data with respect to user data dealt with in a window corresponding to the management information on the object to be subjected to the preview process has been created in the data creating process. Then, if it is determined that the print preview image data is not created (No in the process S460), the corresponding main preview process is completed, and if it is determined that the print preview image data has been created (Yes in the process S460), the task Z proceeds to a process S470.

In the process S470, the task Z determines whether or not a user has set the plural display mode to ON by manipulating the main screen GM, and then if it is determined that the plural display mode is not set to ON (that is, the plural display mode is set to OFF) (No in the process S470), a currently displayed preview screen GP is deleted from the main screen GM (S480). Then, in a process S490, a preview screen GP, on which an image based on the print preview image data created by the data creating process in the process S450 is displayed, is displayed on the main screen GM. Then, the main preview process is completed.

FIG. 7A is an explanatory view illustrating a main screen GM when a window button displayed as ‘D1’ is clicked through the input device 19. For example, in the main preview process, when a user clicks the window button of ‘D1’ displayed on the main screen GM through the input device 19, No is determined in the process S430, management information corresponding to the window button is set to an object to be previewed (S440), print preview image data with respect to the user data D1 included in the management information is created by using a print program of the application software A (S450), a preview screen (for example, a preview screen GP shown by a dot line in FIG. 7A) being displayed is deleted (S480), and a preview screen GP, based on the print preview image data, with respect to the user data D1 is displayed on the main screen GM (S490).

On the other hand, if it is determined that the plural display mode is set to ON in the process S470 (Yes in the process S470), the task Z does not perform the process S480 so as to proceed to the process S490. In the process S490, a preview screen GP, on which an image based on the print preview image data created by the data creating process in the process S450 is displayed, is displayed on the main screen GM.

For example, when a user clicks the window button of ‘D1’ displayed on the main screen through the input device 19, the print preview image data with respect to the user data D1 is created (S450), both the preview screen (for example, the preview screen GP shown by a dot line in FIG. 7A) being displayed and the preview screen GP with respect to the user data D1 are displayed on the main screen GM (S490). Then, the main preview process is completed.

In addition, if it is determined that the button to be processed is an application button in the process S430 (Yes in the process S430), the task Z proceeds to a process S510. In the process S510, the entire management information, in which an application button ID corresponding to the button to be processed is included, is set to an object to be subjected to a preview process.

Subsequently, the task Z determines whether or not a user has set the plural display mode to ON by manipulating the main screen GM (S520), and then if it is determined that the plural display mode is not set to ON (that is, the plural display mode is set to OFF) (No in the process S520), a currently displayed preview screen GP is deleted from the main screen GM (S530), proceeding to a process S540. On the other hand, if it is determined that the plural display mode is set to ON (Yes in the process S520), the task Z proceeds to the process S540 without performing the process S530.

In the process S540, the task Z determines whether or not objects which have not been subjected to the preview process exist during the process S550, and then if it is determined that objects which have not been subjected to the preview process exist (Yes in the process S540), one of the objects which have not been subjected to the preview process is selected (S550). Then, management information on the selected object which has not been subjected to the preview process is set to an object for which data is to be created and the data creating process shown in FIG. 8 is performed (S560).

Further, when the data creating process is completed in the process S560, the task Z proceeds to a process S570. In the process S570, it is determined whether or not print preview image data with respect to user data dealt with in a window corresponding to the management information on the selected object to be subjected to the preview process has been created in the data creating process. Then, if it is determined that the print preview image data is not created (No in the process S570), the task Z proceeds to the process S540, and if it is determined that the print preview image data has been created (Yes in the process S570), the task Z proceeds to a process S580 in which a preview screen GP, on which an image based on the print preview image data created by the data creating process in the process S560 is displayed, is displayed on the main screen GM. In addition, in a case in which a preview screen GP having been displayed before the process S580 is performed exists, the new preview screen GP, which is based on the print preview image data and created in the process S560, is displayed together with the preview screen GP having been displayed before the process S580 is performed.

Thereafter, when the process S580 is completed, the task Z proceeds to the process S540. In the process S540, when objects which have not been subjected to the preview process still exist (Yes in the process S540), one of the objects which have not been subjected to the preview process is selected (S550), a data creating process for the one object is performed (S560), and a preview screen GP corresponding to the one object is displayed together with a previously displayed preview screen GP (S580).

On the other hand, if it is determined that objects which have not been subjected to the preview process do not exist (No in the process S540), the task Z completes the corresponding main preview process.

That is, when an application button is clicked, in the main preview process, all of the preview screens with respect to user data dealt with in a window corresponding to each management information, which includes an application button ID corresponding to the application button, are displayed in parallel.

FIG. 7B is an explanatory view illustrating a main screen GM when an application button displayed as ‘application A’ is clicked through the input device 19. In the main preview process, when a user clicks an application button displayed as the ‘application A’ on the main screen GM, management information corresponding to each of the windows W1, W2, and W3 with respect to the application software is set as an object for which data is to be created and print preview image data with respect to user data D1, D2, and D3 displayed on the windows W1, W2, and W3 is created (S560), and preview screens GP, on which print output results with respect to the user data D1, D2, and D3 are displayed, are displayed in parallel on the display screen G4 (S580).

Accordingly, only by clicking an application button, a user can check a print output result (preview screen) with respect to user data, which is open on a window corresponding to application software corresponding to the application button, on the main screen GM.

Until now, the information processing apparatus 1 of the present illustrative aspect has been described. According to the information processing apparatus 1, application software, which is designated by a user through the input device 19, is registered in a registered application management table (S170), and in the registered application software, management information with respect to each window corresponding to application software being executed is registered in a window management table (S180 to S210).

Subsequently, by assigning a window button ID for the management information on each of the windows, each of the windows is set as an object to be previewed (S220), and lists (for example, window buttons) of each of the windows are displayed on the main screen GM (S240). Furthermore, by assigning, for the management information on each of the windows, an application button ID of corresponding application software (S230), each application software is set as an object to be previewed (S230), and in the registered application software, lists of the application software being executed are displayed on the main screen GM (S240).

Further, when a user selects a window button or an application button through the input device 19 by clicking the window button or the application button displayed on the main screen GM, the clicked button is set to an object to be processed (S420), one or plural management information (that is, a window) corresponding to the button to be process is selected as an object to be subjected to a preview process (S440 and S550). Then, print preview image data, which represents a print output result with respect to user data displayed by a task managing a window corresponding to the object to be subjected to a preview process, is created (S450 and S560), and the preview screen GP, on which an image based on the print preview image data is displayed, is displayed on the display device 17 (S490 and S580).

Therefore, according to the information processing apparatus 1 of the present illustrative aspect, a user can check the print output result with respect to desired data only by clicking a button corresponding to user data, of which a print output result needs to be checked, among a group of window buttons or a group of application buttons displayed on the main screen GM in a GUI format.

That is, in a case in which a user desires to check print output results with respect to a plurality of data, even though the user does not operate a window corresponding to each data so as to display a menu and does not instruct a print preview to be performed through the menu, it is possible to easily check the print output results with respect to the plurality of data only by clicking a button on the main screen GM. As such, according to the present illustrative aspect, it is possible to improve the operability in checking the print output results with respect to the plurality of data on the display device 17, as compared with that in the related art.

Further, according to the present illustrative aspect, since the information processing apparatus 1 can display a plurality of preview screens at the same time, a user can display preview screens with respect to different data at the same time and check the print output results with respect to the plurality of data at one time. In addition, according to the present illustrative aspect, since a user can select application software button-displayed on the main screen GM, it is very convenient for the user to be able to customize the kind of a window button and an application button displayed on the main screen GM.

Furthermore, in the present illustrative aspect, window buttons are displayed on the main screen GM in a window unit, and when one of the window buttons is clicked, the preview screen GP with respect to user data used in a window corresponding to the one window button is displayed. Accordingly, in the information processing apparatus 1, for example, when user data is opened by using a plurality of windows, it is possible to check the print output results with respect to the plurality of data with a simple manipulation.

In addition, in the present illustrative aspect, when the print preview image data with respect to the user data is created, print data with respect to the user data is created by using a print program of application software corresponding to a task which performs a display process for the user data (S330), and the print data is converted to the print preview image data (S340).

Therefore, according to the present illustrative aspect, even though application software does not have a function of creating print preview image data, it is possible to display a preview screen with respect to user data created by the application software. In addition, even though a conversion program is not provided for each data format corresponding to each application software, preview screens with respect to user data having various data formats can be easily displayed.

In addition, in the present illustrative aspect, application buttons are displayed on the main screen GM in an application software unit, and accordingly, when one of the application buttons is clicked, a task based on the application software corresponding to the clicked application button displays, for each window, the preview screen GP with respect to user data (that is, user data opened on each window created by the application software) which performs a display process for each window of the application software.

Accordingly, a user can check the print output result with respect to user data of each window corresponding to the application software only by selecting the application software displayed on the main screen GM. In other words, according to the present illustrative aspect, since preview screens with respect to user data of windows each belonging to a specific group (one application software) can be checked at the same time only by clicking corresponding application buttons, it is possible to improve the operability in checking the print output results with respect to the plurality of data, as compared with that in the related art.

Further, in the present illustrative aspect, a setting unit of the invention is realized by the processes S120 to S230, and a list display unit is realized by the process S240. In addition, a selection unit is realized by the processes S420, S440, and S510, and an image data creating unit is realized by the processes 450 and S540 to S560. In addition, a preview unit is realized by the processes S490 and S580.

In addition, the information processing apparatus and the program of the invention are not limited to the illustrative aspect described above, but may be realized in various ways.

For example, even though the window buttons and the application buttons are displayed on the main screen GM, the print preview image data with respect to the corresponding user data are created in a window unit or in an application software unit, and the preview screen GP based on the print preview image data is displayed in the illustrative aspect, it would be even more convenient if a preview tool is configured such that a plurality of windows are set in a unit of group and a user can select the preview screens GP displayed at the same time.

For example, a window dealing with document data and a window dealing with drawing data may be grouped. Here, by configuring a preview tool such that the task Z can simultaneously display a preview screen GP corresponding to the document data and a preview screen GP corresponding to the drawing data on the main screen GM when a user clicks corresponding one button, the user can check, for example, print output results with respect to the document and the drawing appended to the document at the same time only by one click.

What is claimed is:

1. An information processing apparatus having a print preview function, comprising:
a setting unit that sets preview objects;
a list display unit that displays a list of the preview objects set by the setting unit on a display device;
a selection unit that selects at least one of the preview objects based on a selection instruction input from an input device from the list displayed on the display device;
an image data creating unit that creates print preview image data showing a print output result with respect to user data corresponding to the preview object selected by the selection unit; and
a preview unit that displays, on the display device, an image based on the print preview image data.

2. The information processing apparatus according to claim 1, wherein
the preview unit displays a plurality of images based on the print preview image data simultaneously.

3. The information processing apparatus according to claim 1, wherein
the setting unit sets the preview object based on an instruction input from the input device.

4. The information processing apparatus according to claim 1, further comprising
a multi-task operating system that displays a plurality of windows on the display device, wherein:
the setting unit assigns the preview objects to a window;
the image data creating unit creates the print preview image data with respect to the user data; and
the user data is displayed on the window of the selected preview object by a task that manages the window.

5. The information processing apparatus according to claim 4, wherein:
the image data creating unit includes a program;
the program creates print data with respect to the user data; and
the image data creating unit converts the created print data to the print preview image data.

6. The information processing apparatus according to claim 1, further comprising
a multi-task operating system that displays a plurality of windows on the display device, wherein:
the setting unit assigns the preview objects to a group having one or a plurality of windows;
the image data creating unit creates the print preview image data with respect to the user data; and
the user data is displayed on a window by a task that manages the each windows belonging to the group.

7. The information processing apparatus according to claim 1, further comprising
a multi-task operating system that displays a plurality of windows on the display device, wherein:
the multi-task operating system assigns the plurality of windows for an application software;
the setting unit assigns the preview objects to the application software;
the image data creating unit creates the print preview image data with respect to the user data; and
the user data is displayed on each window by a task based on the application software of the selected preview objects.

8. The information processing apparatus according to claim 7, wherein
the image data creating unit includes a program;
the program creates print data with respect to the user data; and
the image data creating unit converts the created print data to the print preview image data.

9. A computer program product for enabling a computer to have a print preview function, comprising:
software instructions for enabling the computer to perform predetermined operations; and
a computer readable medium bearing the software instructions, wherein
the predetermined operations includes:
setting a preview object;
displaying a list of the preview object set by the setting;
selecting at least one of the set preview objects based on a selection instruction input on the basis of the list;
creating print preview image data showing a print output result with respect to user data corresponding to the preview object selected by the selecting; and
displaying an image based on image data created by the creating.
